(19) United States
(12) Patent Application Publication
(10) Pub. No.: US 2005/0214402 A1
(43) Pub. Date: Sep. 29, 2005

(54) Method and apparatus for forming a block having a textured surface

(76) Inventor: Raymond R. Price, Rochester, MN (US)

Correspondence Address: MOORE, HANSEN & SUMNER, PLLP, 225 SOUTH SIXTH ST, MINNEAPOLIS, MN, 55402, US

(21) Appl. No.: 10/506,172

(22) PCT Filed: Nov. 14, 2001
(86) PCT No.: PCT/US01/43875

§ 371 Date: Apr. 28, 2005

(51) Int. Cl. A23P 1/00

(52) U.S. Cl. 425/441

(57) ABSTRACT

A block texturing apparatus (10) and method for forming a block with a textured surface. The block texturing apparatus (10) has a body (20) with a front surface (22), a rear surface (24), a top surface (26), a bottom surface (30), and opposing side surfaces (36, 38). The front surface (22) has a block modifying section (40) that occupies at least twenty percent of the front surface (22) of the body (20). In operation, the block texturing apparatus (10) is used in conjunction with or in lieu of a wall of a mold (70). The mold (70) is than filled with a mixture of block material (90) that is compressed in the mold (70) to form a block (94). The block (94) is then stripped from the mold (70). As the block (94) is removed, the block modifying section (40) manipulates a surface of a block (94) and imparts an irregular texture (96) thereto.

### BACKGROUND OF THE INVENTION

The present invention is relates to the manufacture of masonry blocks. More specifically, the present invention relates to an apparatus used in conjunction with a masonry block mold, and which imparts a texture to the block as it is removed from the mold.

Manufactured masonry blocks have been used for many years to construct a wide variety of structures. One reason that they have enjoyed their popularity is that they may be formed into many shapes and may include different surface finishes. For example, a masonry block may be in the shape of a “cinder block” and have substantially smooth front and rear surfaces. Or, a masonry block may be in the shape of a retaining wall block and have split-face or roughened surface. Typically, the rustic look is achieved by constructing a mold so that two blocks are formed together in a face-to-face relation, removing the unitary block from the mold, and then splitting the block apart at a common plane to form two blocks, with each block having a roughened surface. This procedure, however, requires additional time to perform, specialized equipment, and trained operators, and this all adds to the cost of manufacture. Various attempts have been made to simplify the process of manufacturing a masonry block having a roughened surface.

One attempt can be found in U.S. Pat. No. 3,904,229 to Hutton. In this disclosure, a roughened surface is formed on a block by providing a lip that protrudes inwardly from the bottom of a wall in a mold. As a block is stripped from its mold, the lip scrapes or otherwise tears the surface to form a roughened surface. This device has its disadvantages in that block material tends to collect above the lip as a block is stripped from a mold. This reduces the effectiveness of the lip and requires that the mold be periodically cleaned for optimum operation. Moreover, this device is limited to the type of texturing that may be imparted to the surface of a block.

Other attempts, such as U.S. Pat. Nos. 5,078,940 and 5,217,630 (both to Sayles) are similar to the patent of Hutton in that block material remains within the mold as a block is stripped therefrom. Sayles differs from Hutton, however, in that this retention of material is intentional. In order to retain material in his mold, Sayles provides one of the walls of his mold with a relatively elaborate series of projections and a reinforcing mesh. A roughened surface is formed as this retained block material is sheared from a block as it is stripped from a mold. This attempt has its disadvantages in that the block material retained within the mold must be periodically replaced in order to be effective.

Still other attempts, such as U.S. Pat. Nos. 5,879,603 and 6,138,983 (both to Sievert) form a roughened surface by providing inwardly protruding upper and lower lips at the top and bottom, respectively, of a wall of a mold. These lips retain a portion of block material therebetween and facilitate a shearing action as a block is stripped from a mold. The lower lip also is used to a lesser extent to further work the surface of a block as it is being stripped from the mold. This attempt has its disadvantages in that, like the afore-mentioned patents of Hutton and Sayles, a portion of block material is still retained by the mold, and processing of this material requires additional time and steps.

The above-mentioned patents of Hutton, Sayles, and Sievert also share the same disadvantage in that they are more or less designed to be part of the mold itself. That is, they are limited to use an as a wall of a mold. There is no provision for use with existing molds, as for example, a divider plate. They also share the same disadvantage in that the surface areas that mechanically work a surface of a block as it is stripped from a mold are small. Thus, the degree to which a surface texture may be formed by mechanically working, is limited.

In other attempts, such as U.S. Pat. Nos. 6,113,379 and 6,224,815 B1 (both to LaCroix et al.) roughened surfaces are simultaneously formed on two blocks by providing a mold with an expanded-metal dividing grate. The grate operates similarly to the above-mentioned patents of Sievert in that a roughened surface is formed primarily by shearing and to a lesser extent, mechanical working. This attempt also has its disadvantages. Its use and placement is limited to bisecting an existing mold. It cannot be used as a wall of a mold. It is structurally weak and subject to wear and tear. Also, it is limited to use with planar surfaces.

The above-mentioned patents of Hutton, Sayles, Sievert, and LaCroix also share the same disadvantage in that their block texturing molds retain a significant amount of waste material on their texturing devices, and this material eventually falls from the texturing devices onto the pallets, machinery, and newly formed blocks therebelow. This waste material not only interferes with normal operation of the machinery, but also creates unsafe working conditions, and may even ruin the newly created, but uncured blocks. Therefore, the block forming machinery must be periodically stopped and cleaned, and the blocks must be checked for waste material before they are cured.

There exists a need for a block texturing apparatus that is able to create a variety of different surface textures. There is also a need for a block texturing apparatus that generates a minimum amount of block material waste, and is self-cleaning. There is also a need for a block texturing apparatus that may be easily incorporated as a wall of a mold or as an internal divider plate within a mold.

### SUMMARY OF THE INVENTION

The present invention provides a block texturing apparatus and a method for use in producing a block with a textured surface. The block texturing apparatus comprises a body having front surface, a rear surface, a top surface, a bottom surface, and opposing side surfaces. The front surface is provided with a block modifying section that is configured and arranged to form a textured surface on a block. This is accomplished in two ways. First, a textured surface is imparted to a block mixture by the block modifying section as a block is formed in a block mold. And second, the textured surface is manipulated by the block modifying section as the newly formed block is removed from the mold. In the context of this application, the term “front surface” is understood to mean the side of the block texturing apparatus that faces the interior of a mold cavity and which contacts block material (or mixture) in a mold.

The block modifying section may vary in size from being substantially coextensive with the front surface, to occupying a percentage of the front surface, for example around twenty percent. The block modifying section may be provided with a variety of profiles that produce different surface textures in a block surface. For instance, the block modifying section may comprise a plurality of parallel channels that are oriented so that they are angled with respect to the direction of removal of a block from a mold. This allows block material within the channels to be worked and redistributed over the surface of a block in churning and repacking motions.

The channels may also be varied cross-sectionally along their length, as well as with respect to each other. Thus, one channel may have a predetermined cross-sectional area and the next channel may have a predetermined cross-sectional area that is smaller or larger than the predetermined cross-sectional area of the first channel. The channels may also vary in depth along their length. They may also be provided with constrictions or shelves (at the bottom end of the block texturing apparatus) to produce, eliminate, or accentuate different textures. Preferably, the channels are v-shaped. However, it is understood that other configurations are possible, for example, a u-shape, a squared notch shape, or a hemispherical shape. It is also understood, that the channels need not all have the same general cross-sectional profile. Thus one channel may be v-shaped and the next channel may be u-shaped, and the next channel may be yet another shape.

Alternatively, it is envisioned that the block modifying section comprise a series of indentations and/or protrusions that churn, redistribute, and repack block material. Further, it is also envisioned that the indentations and/or protrusions may be similar or different in shape, and distributed in ordered or random patterns.

The block texturing apparatus is configured and arranged for use in conjunction with existing block molds and mold machinery. More specifically, the block texturing apparatus may be used in lieu of a mold wall to form a mold enclosure, used in conjunction with existing mold walls, or as in an insert adjacent an existing wall. When used in conjunction in lieu of existing mold walls, the block texturing apparatus is substantially the same size as a mold wall it replaces. However, it will be appreciated that this need not be the case. For example, the block texturing apparatus may have larger extents than the other walls of the mold. For example, the top and bottom surfaces of the block texturing apparatus may extend beyond the upper and lower edges of the mold. This would also produce different textures to a block surface.

When the block texturing apparatus is used with used in conjunction with existing mold walls, it may function as a divider plate or an insert. In this regard, the block texturing apparatus would serve as a common wall between adjacent molds. The block texturing apparatus may be used to bisect a mold, or it may be used to form asymmetric blocks, if desired. Additionally, more than one block texturing apparatus may be used with an existing mold. Thus, for example, a mold may be configured to manufacture a block having textured, faceted front surfaces, or a mold may be configured to manufacture a block having textured front and rear surfaces.

In a variation of the above-mentioned use, a block texturing apparatus may be placed next to an existing wall of a mold. This could be done to accomplish two things. First, to impart a texture to a surface of a block, and second, to change the dimensions of the block mold.

The block modifying section may be formed into different shapes, depending upon the particular shapes of the block molds that are used. For example, the block modifying section may be substantially planar or curvilinear. Alternatively, the block modifying section may be a combination of planar and curvilinear surfaces.

An object of the present invention is to provide a block texturing apparatus that manipulates surfaces of masonry blocks as they are removed from block molds.

Another object of the invention is to simplify the process of forming masonry blocks with textured surfaces as part of the molding process.

A feature of the present invention is that the block texturing apparatus may form part a mold enclosure, or may be used in conjunction with an existing mold enclosure.

Another feature of the invention is that the block texturing apparatus manipulates a surface of a masonry block as it is being removed from a mold.

Yet another feature of the invention is that the block texturing apparatus includes a block modifying section that that is self-cleaning.

An advantage of the present invention is to provide a block texturing apparatus that may be used in conjunction with existing block making equipment.

Yet another advantage is that the amount of waste material created during the texturing process is minimized.

These and other objectives, features and advantages of the invention will appear more fully from the following description, made in conjunction with the accompanying drawings wherein like reference characters refer to the same or similar parts throughout the several views. And, although the disclosure hereof is detailed and exact to enable those skilled in the art to practice the invention, the physical embodiments herein disclosed merely exemplify the invention, which may be embodied in other specific structure. While the preferred embodiment has been described, the details may be changed without departing from the invention, which is defined by the claims.

### DESCRIPTION OF THE DRAWINGS

FIG. 1 is a perspective view a preferred embodiment of the apparatus depicting a body with a block modifying section that is coextensive with the front surface of the apparatus;

FIG. 2 is a cross-sectional view of the apparatus of FIG. 1 taken along lines 2-2, depicting the profile of the block modifying section and the body thickness at the top surface of the body;

FIG. 3 is a cross-sectional view of the apparatus of FIG. 1 taken along lines 3-3, depicting the profile of the block modifying section and the body thickness adjacent the bottom surface of the body;

FIG. 4 is a cross-sectional view of the apparatus of FIG. 1 taken along lines 4-4, depicting the profile of the block modifying section and the body thickness at the bottom surface of the body;

FIG. 5 is a side elevational view of the apparatus of FIG. 1, depicting a preferred taper of the block, and a preferred taper of a single channel with a bottom ledge;

FIG. 6 is a perspective view of an embodiment of the invention as depicted in FIG. 1 and as it may be used in conjunction with a single mold, or a double mold as shown in dashed lines;

FIGS. 7a, 7b and 7c depict steps in the process by which a block is formed with a textured surface;

FIGS. 8a, 8b, 8c, and 8d depict alternative embodiments of the apparatus of FIG. 1; and

FIG. 9 is a perspective view of the lower end of an embodiment of the present invention depicting the juxtaposition channels and shelves.

### DETAILED DESCRIPTION

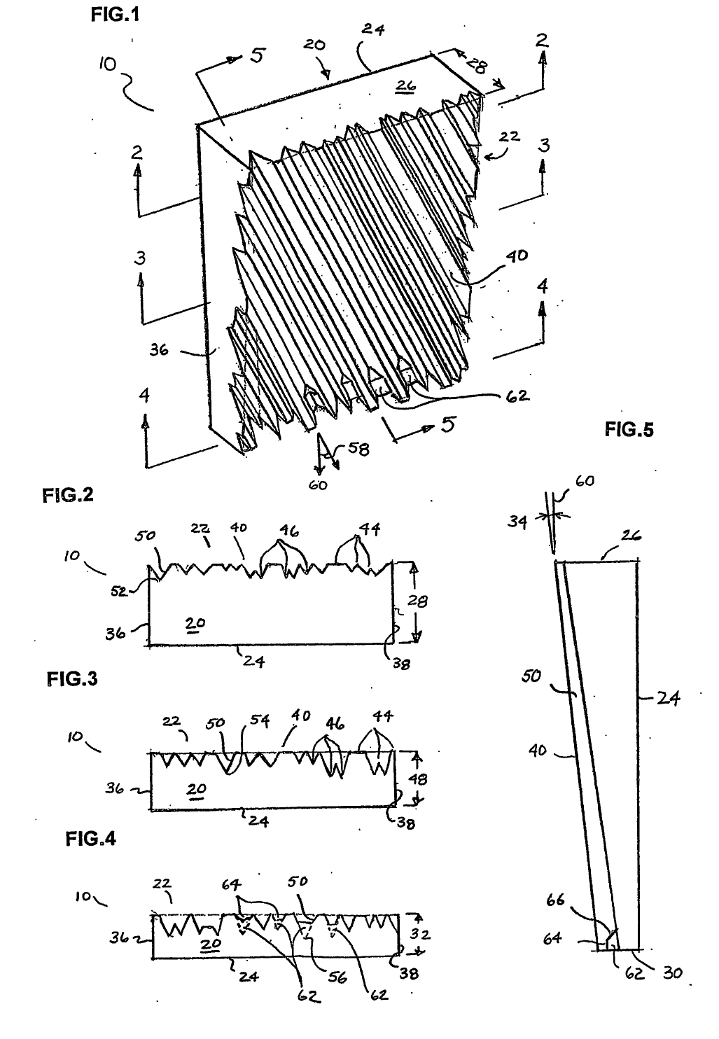

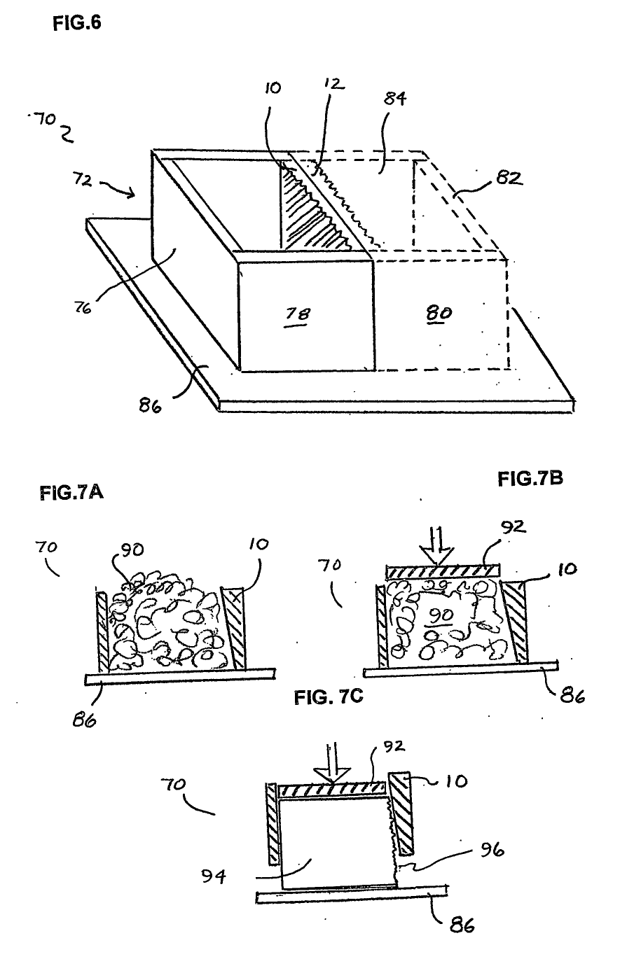

Referring generally now to the drawings and to FIG. 1, a preferred embodiment of a block texturing apparatus 10 of the present invention as it may be used in conjunction with a masonry block mold (see 70, FIG. 6) is shown. The block texturing apparatus 10 comprises a body 20 having a front surface 22, a rear surface 24, a top surface 26, a bottom surface 30 and opposing side surfaces 36, 38. For purposes of this disclosure, the term “front surface” is understood to be the surface of the block texturing apparatus 10 that forms a part of a mold cavity. Thus, it is possible for front facing surface of one block texturing apparatus to be in confronting relation to the front facing surface of a second block texturing apparatus. As to the Figures in general, it should be understood that the salient features of the present invention, as depicted, have been exaggerated to facilitate a clearer appreciation of the invention.

Returning to FIG. 1, the front surface 22 of the block texturing apparatus 10 includes a block modifying section 40 that is configured and arranged to manipulate a surface of a block and impart an irregular texture thereto as the block is slidingly moved therepast during removal from a mold. Preferably, for optimum operation, the block modifying section 40 occupies substantially the same area as the front surface 22 of the body 20. It is understood, however, that the block modifying section 40 may occupy a considerably smaller percentage of the front surface 22 and still be able to impart a textured surface to a block as it is being removed from a mold. Alternatively, the block modifying section 40 may comprise a plurality of spaced-apart subsections (not shown). Generally, though, the block modifying section 40 occupies an area that is greater than twenty percent of the front surface 20. And, while the block modifying section 40, as depicted, is generally quadrilateral in shape, it will be appreciated that other configurations are possible depending upon the shape of a particular block to be molded and what type of surface texturing is desired.

The block modifying section 40 itself encompasses an area characterized by having discontinuities. As depicted, the discontinuities of the block modifying section 40 are a plurality of recesses that, together, form an erose or jagged surface. Preferably, the recesses comprise channels 42 that are oriented at a predetermined angle 58 with respect to the direction of removal 60 of a block from a mold. This predetermined angle 58 may range from around zero to forty-five degrees, but the preferred range is around five to twenty-five degrees.

As will be appreciated, different predetermined angles 58 will produce different surface textures. For example, if the predetermined angle is zero, the resulting surface textures can approximate what is known in the trade as a “stri-face.” If the predetermined angle is around forty-five degrees, the resulting surface textures can approximate what it known as a rustic or weathered look. Yet other surface textures are possible with intermediate, predetermined angles.

As mentioned above, the block modifying section 40 occupies substantially the front surface 22 of the body 20, and the channels 42, as depicted, are substantially parallel and continuous in their extent across the front surface 22 of the body 20. However, this need not always be the case. It is envisioned that the channels could be skewed with respect to each other so that they converge and/or diverge. It is also envisioned that the channels vary in width along their longitudinal extents. That is, they may be flared or undulating. Moreover, the channels could be segmented into smaller lengths or links. As mentioned above, the cross-sectional profiles of the channels are 42 substantially v-shaped. This profile is preferred because it facilitates cleaning and makes the block modifying section easier to fabricate. It should be understood, however, that other cross-sectional configurations are possible, for example, a u-shape, or a squared slot.

Referring now to FIG. 2, the block texturing apparatus 10 is shown in cross-section taken at the top surface 26 of the body 20. Here, the cross-sectional profiles of the v-shaped channels 42 and the body 20 can be more easily seen. Note that the channels 42 are delineated by ridges 44 that may be angular or planar, and which may vary in height with respect to the plane of the front surface 22 of the body 20. Similarly, the channels 42 have depths 46 that may vary in height with respect to the plane of the front surface 22 of the body. Preferably, the ridges 44 are at or below the plane of the front surface 22 of the body 20.

To reiterate, the channels 42 need not all have the same cross-sectional profile, and some channels, for example, may be deeper and wider than other channels. For purposes of illustration, however, only one channel 50 in the block modifying section 40 will be described in detail. It is understood, however, that such description may apply to the other channels 42 forming the block modifying section 40. As depicted, the channel 50 is generally v-shaped and extends inwardly from the plane of the block modifying section 40 to a predetermined depth 52. As will be appreciated by those skilled in the art, the particular depth and width of the channel 50 may be varied as desired.

Referring now to FIG. 3, the block texturing apparatus 10 is shown in cross-section taken between the top and bottom surfaces 26, 30 of the body 20. Note, that the channel 50 has shifted with respect to its location depicted in FIG. 2. This is reflective of the predetermined angle 58 that the channel 50 makes with respect to the direction of removal 60 of a block from a mold (see, FIG. 1). Note also, that the body 20 now has a thickness 48 that is less than the thickness 28 as depicted in FIG. 1. This is also reflective of the predetermined angle 34 that the block modifying section 40 makes with respect to the direction of removal 60 of a block from a mold (see, FIG. 5). Finally note, that the channel 50 now has a depth 54 that is greater than the depth 52 as depicted in FIG. 1. This is to reflect changes that may occur in the profile of the channel 50.

Referring now to FIG. 4, the block texturing apparatus 10 is shown as a cross-sectional slice taken at the bottom surface 30 of the body 20. Note that the channel 50 has shifted further with respect to its location as depicted in FIG. 3. Also, note that the body 20 now has a thickness 32 that is less than the thickness 48 as depicted in FIG. 3. And, note that the channel 50 now has a depth 56 (depicted in dashed lines) that is greater than the depth as depicted in FIG. 3. As will be appreciated, changing the depth of the channel 50 will change the texturing characteristics of the block modifying section 40. In FIGS. 2-4, the depth of the channel 50 doubles as it traverses from the top to the bottom of the block modifying section 40. And, while the aforementioned changes in depth are linear along the extent of the block modifying section 40 of the body, it is understood that such changes may be non-linear, if desired (not shown). Generally, however, it is preferred that the channel 50 has a substantially constant depth as it traverses from the top to the bottom of the block modifying section 40.

Referring now to FIG. 5, the predetermined angle 34 that the block modifying section 40 makes with respect to the direction of removal 60 of a block from a mold, and the change in depth that occurs in channel 50 between the top and bottom of the block modifying section 40 can be more easily seen. Since the block texturing apparatus 10 is generally configured and arranged so that it may be used in conjunction with or in lieu of a wall in a block forming mold, the body 20 is provided with generally parallel top 26 and bottom 30 surfaces, as well as generally parallel opposing side surfaces 36, 38. The front and rear surfaces 22, 24 need not be parallel, and may be oriented at a predetermined angle 34 with respect to each other. As can be seen, the top surface 26 has a first thickness 28 and the bottom surface 30 has a second thickness 32 (see also, FIGS. 1, and 4).

Preferably, the top thickness 28 is greater than the bottom thickness 32, so that the body 20 of the block texturing apparatus 10 forms a taper. The difference need not be great, and the resulting predetermined angle 34 may be relatively small, around the range of zero to ten degrees, but preferably the predetermined angle 34 is around one to five degrees with respect to the direction of movement 60 of a block as it is separated from a mold. The reason being that tilting or otherwise shifting the block modifying section 40 facilitates greater manipulation of a surface of a block as it is removed from a block, and also enables the channels of the block modifying section 40 to self-clean. In this regard, it is envisioned that the block texturing apparatus be adjustable relative to the mold, to enable changes to be made in the field. This could be achieved by providing adjustment screws or shims, or by using technologies and techniques known to the art (not shown). Thus, block surface textures could be tailored to a particular situation.

Referring now to FIG. 6, a block texturing apparatus 10 is depicted as it may be used in several molds. On the left, in solid lines, a block texturing apparatus 10 is shown as it may be used with a single mold in which it forms part of the mold enclosure 72. In this situation, the block texturing apparatus 10 is operatively connected to walls 74, 76, and 78 to form the enclosure 72. The enclosure 72 is than positioned on a mold support 86 to form a cavity into which block material is loaded, and the mold is than used in the normal fashion.

Alternatively, a plurality of block texturing apparatuses 10, 12 may be used in conjunction with a mold enclosure. As depicted in both solid and dashed lines, the mold enclosure 72 now includes walls 80, 82 and 84. Here, the block texturing apparatuses 10 and 12 are arranged and oriented for use as division plates. In this situation, the rear surfaces of the block texturing apparatuses 10, 12 are in a confronting relation and the front surfaces are facing away from each other. Thus, the mold is able to form two blocks having textured surfaces. Other placements of the block texturing apparatuses within an existing mold are possible. For example, the rear surface block texturing apparatus 10 could be placed in confronting relation to wall 82 and the rear surface of block texturing apparatus 12 could be placed in confronting relation to wall 76. This would position the front surfaces of the block texturing apparatuses 10, 12 towards the interior of the mold such that the resulting mold would then be able to produce a block with opposing textured surfaces. It should be apparent, then, that any molded block may have one or more its surfaces textured by practicing the invention.

Referring now to FIGS. 7a, 7b and 7c, the process of forming a block with a textured surface will now be briefly discussed. In FIG. 7a, a mold 70 having a block texturing apparatus 10 as one of its walls is positioned onto a mold support 86 to form a cavity. A predetermined charge of block mixture (or material) 90 is then loaded into the cavity. A top plate 92 is than brought into position adjacent the open end of the cavity as shown in FIG. 7b, and moved towards the mold support 86. As the top plate 92 moves towards the mold support 86 the block mixture 90 is compressed within the cavity to form a block 94 of material. After compression, the newly formed block 94 is removed from the mold 70 by moving the mold relative to the mold support 86 and the top plate 92. As the block 94 is removed from the mold 70 the block texturing apparatus 10 imparts a textured surface 96 thereto as it slidingly moves therepast. After the block 94 has been removed from the mold 70, it is then cured (not shown) in the normal fashion.

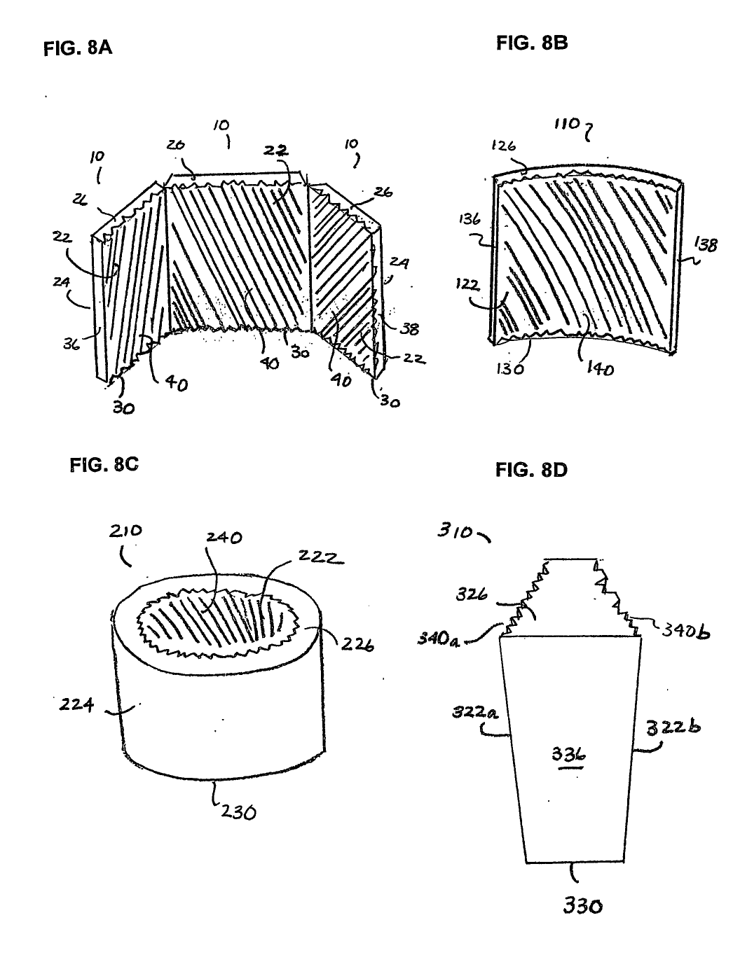

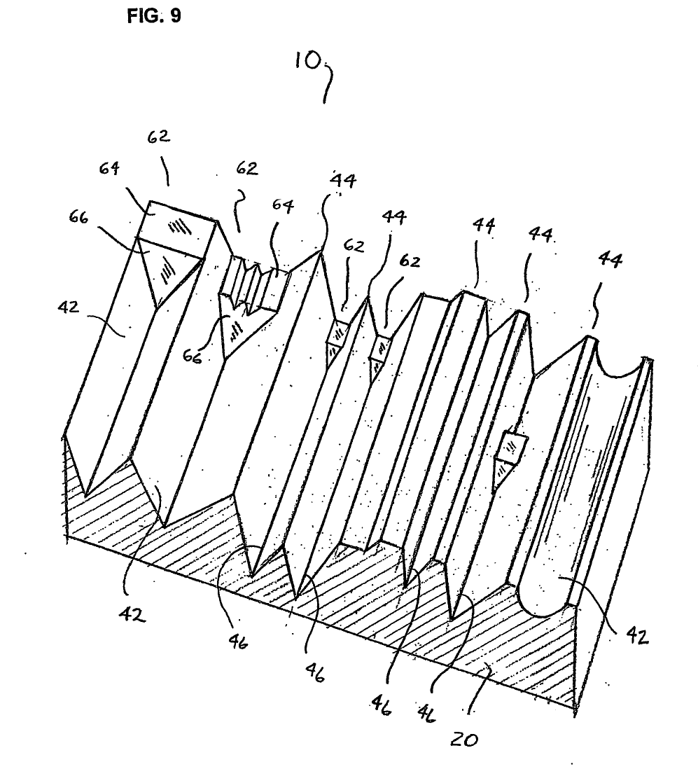

Referring now to FIGS. 8a, 8b, 8c and 8d, alternative embodiments of the block texturing apparatus will now be briefly discussed. In FIG. 8a, a plurality of block texturing apparatuses 10 are arranged for texturing surfaces of faceted blocks. As depicted, the block texturing apparatuses 10 include front surfaces 22, rear surfaces (not shown) top surfaces 26, bottom surfaces 30 and opposing side surfaces 36, 38. Note that the front and rear surfaces 22, 24 of the block texturing apparatuses 10 are not tapered as with the front and rear surfaces of the embodiment of FIGS. 1-5, but are substantially parallel. The block texturing apparatuses 10 are arranged so that they are able to impart texturing to three surfaces or facets of a block, however, it is understood that there could be other faceted configurations. In this depiction, the block modifying sections of the block texturing apparatuses are substantially similar, and would produce similarly textured surfaces. However, it is envisioned that the block texturing apparatuses be provided with different block modifying sections. Thus, a mold would be able to form a block having different textured surface.

In FIG. 8b, the block texturing apparatus 110 includes a front surface 122, a rear surface (not shown), a top surface 126, a bottom surface 130, and opposing side surfaces 136, 138. The block modifying section 140 is substantially coextensive with the front surface 122 of the block texturing apparatus 110, and is configured into a curvilinear surface. In FIG. 8c, the block texturing apparatus 210 includes a front surface 222, a rear surface 224, a top surface 226 and a bottom surface 228. Note that there are no side surfaces. The block texturing apparatus 210 of this embodiment forms an entire mold enclosure, with the block modifying section 240 substantially coextensive with the front surface 222 that defines the interior of the mold, and with the rear surface 224 forming the exterior of the mold. In this particular embodiment the mold it is circular, however, it is understood that other configurations are possible. As to FIG. 8d, the block texturing apparatus 310 is formed with two opposing front surfaces 322a, 322b, having two corresponding block modifying sections 340a, 340b. In this embodiment, the block texturing apparatus 310 may be used as a divider plate.

Referring now to FIG. 9, the bottom of the body 20, as depicted in FIGS. 1, 4, and 5, includes a shelf 62 having a front surface 64 and a transition surface 66. The front surface 64 of the shelf 62 may be coplanar with the plane of the block modifying section 40, or it may be recessed with respect thereto. Moreover, the front surface 64 itself may be grooved or otherwise textured. As depicted here, and also in FIGS. 1 and 4, the front surfaces 64 of the shelves 62 may vary with each individual channel 42. So, for example, the front surface for one channel may be recessed with respect to the plane of the block modifying section, while a front surface for a second channel may be coplanar with plane of the block modifying section, and the front surface for a third channel may grooved or otherwise textured. It should be understood, however, that the front surfaces 64 of the shelves 62 may be coplanar relative to each other, or that they may all be textured, if desired. It should also be understood that the location of the shelves need not be located solely at the bottom of the block modifying section, nor that each channel is limited to only one shelf.

One purpose of the shelf 62 is to assist in redistributing and/or repacking block material on the surface of a block as the block is removed from a mold. Another purpose of the shelf 62 is to reduce and/or soften striations that may be formed by the channel 50. It should be apparent to practitioners in the art that the shelf 62 effectively reduces the cross-sectional area of the channel 50, and that different amounts of reduction will result in different textures that are imparted to the surface of a block. Thus, it will be appreciated that the amount of cross-sectional reduction may be varied from channel to channel. Alternatively, the shelf 62 may be coplanar with the plane of the front surface 22 and extend substantially across the bottom thereof.

The transition surface 66 of the shelf 62 is, depicted as being angled with respect to the front surface 64, however, it is understood that this need not be the case. For example, the transition surface 66, may be orthogonally oriented with respect to the front surface 64. Generally, though, an angled transition surface 66 is preferred for ease of manufacture and cleaning. Alternatively, the front surface 64 of the shelf 62 may be substantially reduced to create an angled shelf that extends inwardly with respect to the plane of the block modifying section 40.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

1-23. (canceled)

24. A hitch for towing vehicles, comprising: a tow bar mounted movably around at least two rotatory axes; a mechanical drive for moving said tow bar between an operating position and an inoperative position drive including means for generating a rotary movement of the said tow bar which is superimposed at least in some areas of said tow bar around said two axes.

25. A hitch in accordance with claim 24, wherein said rotatory axes are directed at right angles to one another.

26. A hitch in accordance with claim 25, wherein said tow bar has a cardanic mount with a drag bearing and with a pivot bearing with said rotatory axes intersecting.

27. A hitch in accordance with claim 24, wherein said mechanical drive has an electric drive motor or a manually operated crank drive.

28. A hitch in accordance claim 24, wherein said tow bar has a curved shape and is mounted with one end rotatable around an axis of rotation which is essentially vertical in the operating position and rotatable around a pivot axis directed essentially in the longitudinal direction of the vehicle.

29. A hitch in accordance claim 28, wherein said tow bar has an angle of rotation of essentially 90° around said vertical axis of rotation and an angle of rotation of about of more than 90° around said longitudinal pivot axis.

30. A hitch in accordance claim 24, wherein said tow bar is mounted at a cross rail for the towing vehicle in a free space of the cross rail.

31. A hitch in accordance claim 30, wherein said tow bar is directed in a direction of the cross rail and dips into the free space of the cross rail in the inoperative position, wherein said tow bar points upward based on a curvature thereof.

32. A hitch in accordance claim 30, wherein said hitch has a seal for closing the free space at the cross rail and/or a rear opening on an underside of the towing vehicle.

33. A hitch in accordance claim 26, wherein said tow bar is mounted with a drag bearing and with a pivot bearing with said rotatory axes intersecting an axis of rotation of the pivot bearing in a housing which is mounted rotatably around said pivot axis with said drag bearing at said cross rail.

34. A hitch in accordance claim 24, wherein said means for generating said superimposed rotary movement is designed as a gear mechanism coupling a pivot axis and an axis of rotation.

35. A hitch in accordance claim 33, wherein a rotary movement of said tow bar around said axis of rotation is derived from a pivoting movement of said tow bar or of said housing.

36. A hitch in accordance with claim 34, wherein said gear mechanism has a plurality of coupled gear mechanism parts and a common drive motor.

37. A hitch in accordance claim 34, wherein said drive motor is moved along and is arranged at said housing or at said tow bar.

38. A hitch in accordance with claim 37, wherein said drive motor moved along acts on a first gear mechanism part designed as a pivoting gear mechanism and has a drive element connected with said drive motor in the form of a worm shaft, and an external, relatively stationary support element meshing therewith.

39. A hitch in accordance claim 38, wherein said stationary support element comprises a gear toothed on a circumference thereof.

40. A hitch in accordance claim 33, wherein a gear mechanism or a gear mechanism part converts a pivoting movement of said housing into a rotary movement of said tow bar around said axis of rotation and is arranged at or in said housing.

41. A hitch in accordance with claim 40, wherein said gear mechanism part has a toothed ring mounted with a controllable rotary locking on said tow bar and rotatable around said axis of rotation and mineshing with a relatively stationary toothed ring.

42. A hitch in accordance with claim 40, wherein said toothed ring has a movable locking element cooperating with a locking opening at said tow bar to form the rotation-locked connection.

43. A hitch in accordance claim 24, wherein said hitch has one or more locking devices for controlling and fixing at least one end position of said tow bar in said operating and/or inoperative position.

44. A bitch in accordance claim 33, wherein said hitch has an electric socket arranged at said tow bar or at said housing such that it can move together with same.

45. A hitch in accordance with claim 24, wherein said hitch has a current transfer means connected with said tow bar and with current-conducting contacts for connection with a towed vehicle coupling.

46. A hitch in accordance with claim 45, wherein said current transfer means has an encoder and a decoder with a line connection associated with said towed vehicle and said towing vehicle.

47. A hitch for towing vehicles, comprising:
a tow bar mounted movably around at least one rotatory axis;
a mechanical drive for moving said tow bar between an operating position and an inoperative position said drive including means for generating a rotary movement of said tow bar,
a towing bracket;
a locking device for locking said tow bar in at least one of said operating position and said inoperative position, said locking device being supported relative to said towing bracket and driven by said mechanical drive via a transmission device, said locking device including a latch plate locking element attached to said tow bar and engageable by a locking element.

48. A hitch according to claim 47, wherein said transmission device exhibits a gear with at least one crank guide connected with the mechanical drive to shift, at an end of the tow bar movement, at least one of the locking element and said latch plate locking element in closing interference with the tow bar.

49. A hitch according to claim 48, wherein said gear is a worm gear.

50. A hitch according to claim 47, wherein said transmission device includes a gear wheel with a movement thread connected with the mechanical drive to shift, at the end of the tow bar movement, said locking element and said latch plate locking element into locking interference.

51. A hitch according to claim 47, wherein said locking element and said latch plate locking element comprise a toothed rack arrangement or locking ball and locking ball mount.

52. A hitch according to claim 47, wherein a part of the locking elements is supported relatively stationarily at said towing bracket.

53. A hitch according to claim 51, wherein one of the locking elements has an opening allowing a ball to be seated therein.

54. A hitch according to claim 53, wherein a rod end of one or more ball mounts is arranged forming the locking element.

55. A hitch according to claim 54, wherein said locking ball mount has recesses arranged at different extent-lateral angle positions at the rod end, which corresponds to an end position of the tow bar in coordination with said openings.

56. A hitch according to claim 55, wherein said worm gear and crank guide are connected to one or more of said locking plate elements to bring the locking elements into interference.

57. A hitch according to claim 47, whereby said drive includes a mechanism for the production of an overlaid rotation of said tow bar around the two axis whereby said tow bar is swivelling and stored.
